(19) United States
(12) Patent Application Publication
(10) Pub. No.: US 2020/0016694 A1
(43) Pub. Date: Jan. 16, 2020

(54) LASER WELDING WITH FILLER WIRE

(71) Applicant: EL COOPER PROPERTIES LLC, Clarklake, MI (US)

(72) Inventors: Edward L. COOPER, Clarklake, MI (US); Alex KHAKHALEV, Ann Arbor, MI (US)

(21) Appl. No.: 16/491,508

(22) PCT Filed: Mar. 6, 2018
(86) PCT No.: PCT/US2018/021104

§ 371 Date: Sep. 5, 2019

Related U.S. Application Data
(60) Provisional application No. 62/467,493, filed on Mar. 6, 2017.

(51) Int. Cl. B23K 26/14; B23K 26/211; B23K 35/02

(52) U.S. Cl. CPC B23K 26/1464; B23K 35/0261; B23K 26/211

(57) ABSTRACT

A fusion welding system utilizing a radiant energy heat source such as a laser or electron-beam. The system uses a weld or filler wire having a non-round cross-section shape oriented such that the minor axis of the filler wire is aligned to intersect or nearly intersect the weld bead line. The filler wire cross-sectional shape provides enhanced surface interaction with the radiant energy heat source and possesses mechanical properties enabling more precise positioning of the wire relative to the radiant energy heat source and the weld area.

### CROSS-REFERENCE TO RELATED APPLICATION

This PCT International Application claims the benefit of priority under 35 U.S.C. § 119 to U.S. Provisional Application No. 62/467,493, filed Mar. 6, 2017, the contents of which are incorporated herein by reference in their entirety.

### FIELD OF THE INVENTION

This invention relates to metal fusion welding processes utilizing radiant energy for applying heat to a metal joint with the use of a filler wire or consumable electrode to provide additional metal for forming a weld bead and joint.

### BACKGROUND AND SUMMARY OF THE INVENTION

The applicant is the developer of numerous innovations in the area of welding technologies including; gas metal arc welding (GMAW), also known as metal inert gas (MIG) welding, metal active gas (MAG) welding, shielded metal arc welding (SMAW), gas tungsten arc welding (GTAW), flux cored arc welding (FCAW), submerged arc welding (SAW), electroslag welding (ESW), electric resistance welding (ERW), and other types and variations of such welding technologies. Among other areas of innovation, the applicants have discovered numerous improvements in the design, transport and equipment for consumable electrodes in the form of a filler or weld wire used in many of these processes. In prior art systems, filler or weld wire is fed through a welding torch to the weld arc area. The wire typically used has a round cross-sectional shape. Applicants have discovered numerous advantages in the use of a non-round cross-section filler or weld wires such as those having an essentially elliptical cross-sectional profile or other shapes for MIG welding and similar processes. Among other benefits, such weld wire configurations provide better electrical contact with the torch tip thereby conducting electric current to the workpiece through the weld wire with less resistance. Such advantages are described and claimed by U.S. Pat. Nos. 8,878,098; and 9,440,304, and as described in the patent application published as US 2015/048056. These prior disclosures have primarily dealt with applications for such wire for MIG and related types of welding processes in which electric current flowing through the wire provides the thermal energy for the fusion welding process.

Numerous systems for welding technologies exist beyond electric arc welding as generally described above. Another field of welding technologies relates to gas welding systems which use a gas as the heat source for melting parent material or additional metal to a weld joint. Another class of welding technologies uses radiant energy such as an electron beam or a high-energy laser beam which act on metal workpieces and/or filler materials to form the fusion weld. In one example of such systems, a laser beam is directed onto the workpiece and at least a portion of the beam cross-section intersects a filler or weld wire which is fed into the weld bead area to provide additional metal for the joint. In traditional laser welding with filler wire processes, filler wire with a round cross-sectional shape is used. Applicants have discovered numerous significant advantages in the application of non-round wires for laser welding processes including those using a radiant energy heat source. For laser welding processes, examples of these improvements relate to the enhanced absorption of laser energy enabled through the orientation of the non-round cross-section wire relative to the beam axis of the laser heat source, as well as exploiting mechanical properties of non-round wire which tend to enable it to be fed in a more precise manner to the weld bead area. The benefits of such non-round wire in radiant energy type welding systems may also be used in a variety of different related welding processes including those that integrate laser or other radiant heat sources with other welding techniques such as MIG welding processes and hybrid MIG/plasma/laser processes.

### BRIEF DESCRIPTION OF THE DRAWINGS

FIG. 1 is a pictorial view of a laser welding system in accordance with the prior art;

FIG. 2 is a view similar to FIG. 1 but showing more detail of the welding system in accordance with the prior art;

FIGS. 3A-3C illustrate the interaction between a laser beam heat source and a round filler wire in three different orientations which depict the prior art;

FIG. 4 illustrates the interaction between a laser beam heat source and a non-circular cross-section filler or weld wire in accordance with the present invention;

FIGS. 5A-5D illustrate various examples of non-round cross-sectional wire shapes which can be used in connection with the present invention;

FIG. 6 is a schematic illustration of a process for preparing weld or filler wire beginning with round cross-section wire stock and creating a flattened non-round filler wire;

FIGS. 7A and 7B illustrate interactions between plural laser energy heat sources and a non-round filler or weld wire;

FIG. 8 is a pictorial view illustrating a hybrid laser/MIG system utilizing features of the present invention; and

FIG. 9 is a pictorial view illustrating a hybrid laser/plasma system utilizing features of the present invention.

FIGS. 10A-10C illustrate various orientations of the cross-section of a filler wire relative to a weld bead joint.

### DETAILED DESCRIPTION OF THE INVENTION

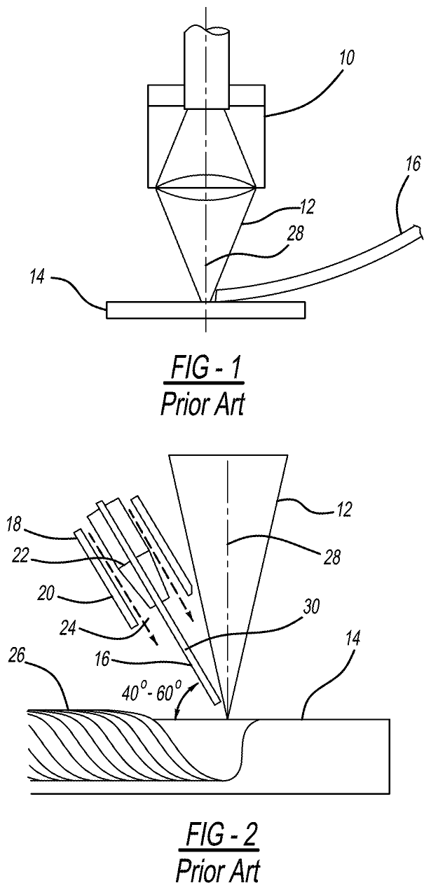

With particular reference to FIGS. 1 and 2, a basic description of a prior art laser welding with filler or weld wire process is shown. FIG. 1 illustrates laser source 10 which presents a focused beam 12 of laser energy onto workpiece 14. Wire 16 is continuously fed through a torch 18 (not illustrated in FIG. 1) to the weld site as laser source 10 and the wire is advanced along a weld bead line along workpiece 14 (most frequently to join separate metal pieces). In such processes, laser source beam 12 is directed to impinge upon filler wire 16 to directly heat the wire by a process of absorption of a portion of the laser energy by the wire material. In an embodiment of the invention, beam 12 has beam properties sufficient to cause melting of the parent material of workpiece 14 as well as the material of filler wire 16.

Referring to FIG. 2, additional features are illustrated of a known laser welding with filler wire system. FIG. 2 shows features of welding torch 18 having nozzle 20 and contact tip 22. A central bore through contact tip 22 guides filler wire 16 to the weld site. As shown, an annular space is present between the outer circumference of contact tip 22 and the inside of tubular nozzle 20 which allows a shielding gas flow 24 to be provided to the weld site to prevent oxidation and control weld properties. Workpiece 14 is shown with torch 18 advancing in the right-hand direction along a weld bead line of the workpiece, as the components are illustrated in FIG. 2. As shown, material of workpiece 14 and wire 16 are melted to create weld bead 26. FIG. 2 also illustrates an orientation between optical axis 28 of beam 12, which is shown as normal or nearly normal to the exterior surface of workpiece 14. FIG. 2 also illustrates that filler wire 16 is fed into the weld joint area at an oblique angle with respect to the workpiece surface and the longitudinal axis 30 of filler wire 16 (designated as 40°-60°).

In one implementation of the process shown in FIG. 2, referred to as a “cold wire” process, filler wire 16 is fed into the weld site area without conducting electric current as is provided in ordinary MIG welding. Hybrid variations of these welding techniques can be provided including a laser/hot electrode wire system in which electric current is conducted through filler wire 16, referred to as a “hot wire” system. Such electric current can be sufficient merely to heat filler wire 16 to a temperature below its melting point which tends to soften the wire and may improve its absorption characteristics of laser energy from beam 12. If a higher current is passed through filler wire 16, MIG welding conditions are provided and additional heating may be provided by laser beam 12 for purposes such as preheating the weld joint, or adding additional energy to the joint, which may be desired to properly precondition the weld area for welding, or to smoothen the weld bead. In such hybrid applications, laser beam 12 may not directly intersect with a surface of filler wire 16 while the wire is in a solid form.

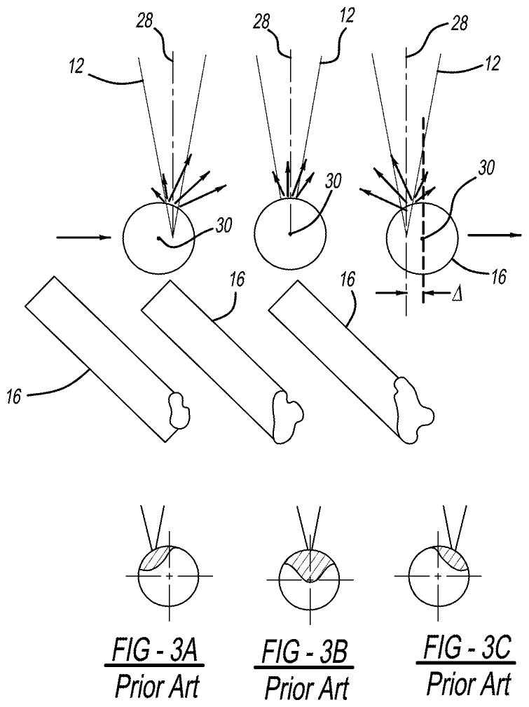

FIGS. 3A-3C illustrate the interaction between laser beam 12 and filler wire 16 of the conventional type system using filler wire 16 with a round cross-sectional shape. The upper portions of these figures show the interaction between the laser beam 12 and the cross-section of the round wire 16; the middle portions show a side view of the filler wire being melted; and the lower portion shows a cross-section of the filler wire 16 being melted. FIG. 3B, at center, illustrates an ideal condition in which the laser beam axis 28 is nearly normal to an impinging surface of filler wire 16 (normal in the plane of the paper) where laser axis 28 intersects the filler wire longitudinal axis 30 along the geometric center of the filler wire cross-section. It is noted that beam 28 is not actually normal to the surface of filler wire 16 in FIG. 3B since, as explained previously, and with particular reference to FIG. 2, there is an angle between beam axis 28 and filler wire axis 30 in the plane of the paper as shown in FIG. 2. However, FIG. 3B illustrates an example of a preferred interaction between filler wire 16 and laser beam 12. The middle portion of FIG. 3B provides a side view of filler wire 16 and shows the melted end of the filler wire 16 which melted material flows into the weld joint. The lower portion of FIGS. 3A-3C provide views of the end of the filler wire 16 showing the position of the molten filler wire material. FIGS. 3A and 3C illustrate a slight deviation or skewing of laser beam axis 28 with respect to the geometric center axis 30 of filler wire 16. Those figures illustrate that, for filler wire with a round cross-sectional shape, the tangent angle of the filler wire surface interacting with the laser beam axis quickly becomes oblique as the beam axis 28 no longer intersects filler wire axis 30, and in fact the optimal condition of FIG. 3B only occurs for some of the rays of laser beam 12 (not all rays of the entire beam cross-section). The off-axis interactions shown in FIGS. 3A and 3C produce a less efficient transfer of energy from laser beam 12 to filler wire 16 attributed to a grazing (off-normal) incidence angle which results in a loss of efficiency of transferred energy, as represented by the reflected ray arrows shown in the upper portions of these figures. Another factor decreasing the efficiency of such skewed laser heating results since the energy distribution across the width of the laser heating beam is generally Gaussian with the maximum intensity at the center of the beam, and this highest intensity portion of the beam is not incident on the normal surface of the wire. Yes I am on thanks Mike The lower portions of FIGS. 3A and 3C show the non-uniform edge heating of the filler wire 16 cross-section in such off-axis interactions. In FIG. 3C the delta “Δ” symbol designates the skewed displacement in the off-axis interaction, which is also present in the example of FIG. 3A.

Theoretically it would be possible to provide nearly the desired orientation illustrated by FIG. 3B in a welding process using round filler wire, but this is not practical due to the highly curved surface of round filler wire, and in view of the fact that in the dynamic and high temperature environment of a welding process, filler wire 16 may tend to wander or deflect as it is being fed into the weld bead area and therefore the wire will tend to deviate between the positions shown in FIGS. 3A-3C.

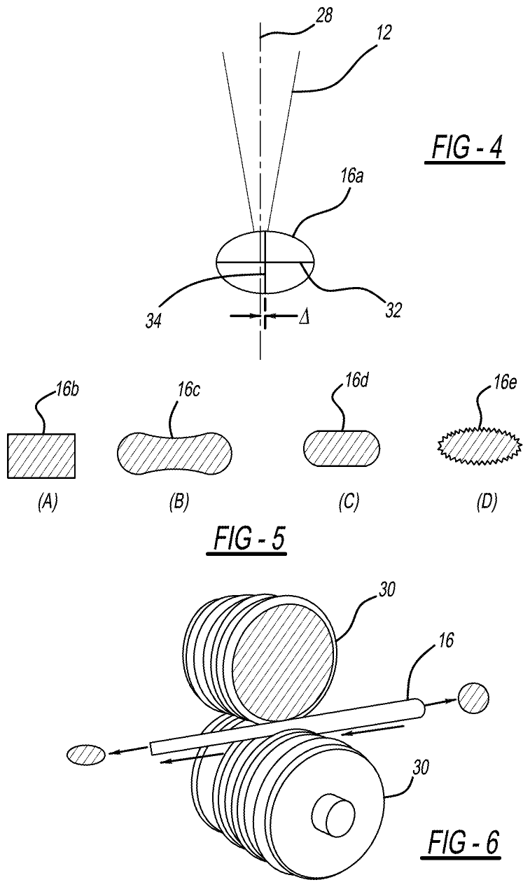

FIG. 4 illustrates an example of filler wire 16a in accordance with an embodiment of the present invention. Filler wire 16a can be characterized as having a generally elliptical cross-sectional shape. Other examples of shapes with deviate from a round cross-section (i.e. formed by a circular perimeter) are oval, a flattened, or other non-round cross-section shapes. Further variations of filler wire 16a may have a circumferential region which is flat or nearly flat (even concave) such as in the form of a flattened tape having a square or rectangular cross-section, or more complex shapes such as “dog bone” type cross-section shapes. Several examples of such alternative non-round alternative cross sectional configurations are shown by FIGS. 5A-5C, including filler wire 16b having a square or rectangular cross-sectional shape with rounded edges, filler wire 16c provide an example of a “dog bone” shape mentioned previously, and filler wire 16d having generally planar parallel surfaces with rounded or curved side surfaces.

In addition to the general cross-sectional form of the filler wire 16 additional features to enhance laser energy absorption may be provided in the form of surface finish treatments, coatings etc. FIG. 5D illustrates a cross-section of wire 16e having a predetermined roughness applied to its outer surface. Such roughness can be in the form of pits or scratches, knurling, serrations, or elongated grooves along the longitudinal axis of the wire. The function of these surface roughness features is to create small cavities where a high degree of internal reflection and therefore absorption of laser energy occurs with the desire to mimic the behavior of an idealized blackbody energy absorber. The roughness may be impressed through forming operations on finished solid wire or can be created during the process of forming the wire. Another alternative form for filler wire 16 could be provided in the form of a bi-metal wire with, for example, outer cladding of a material provided for desired alloying characteristics or for mechanical characteristics. For example, an outer cladding could be a metal providing a higher stiffness to give the finished wire desired stiffness and positioning accuracy during welding processes.

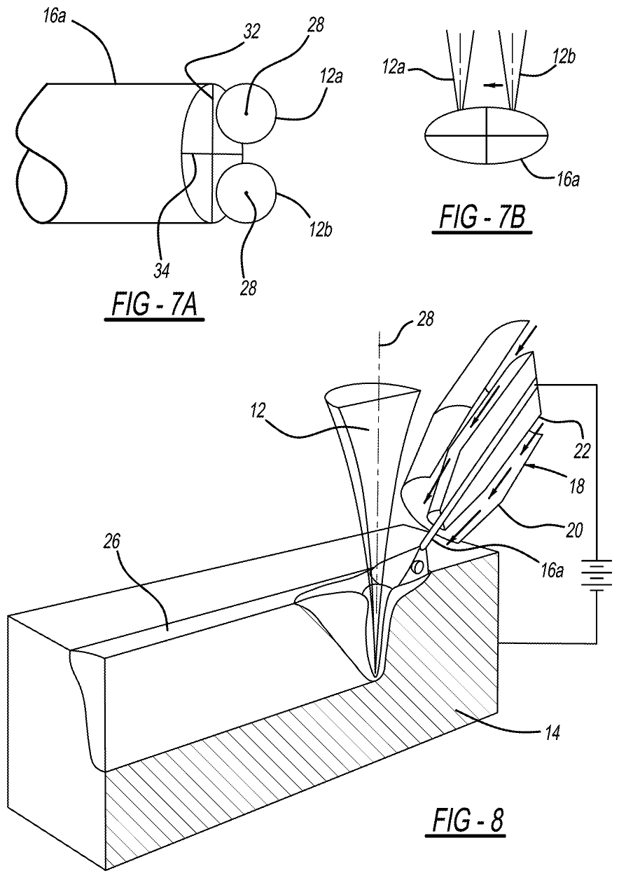

Filler wire 16a-d may be formed with an initially circular cross-section shape and later cold-formed, for example through a rolling process or extrusion to produce opposing flattened or shaped surfaces. An example of such a process is schematically represented by FIG. 6, showing wire stock 16 fed through a pair of driven rollers 30 which form the wire to a non-round shapes such as examples of wires 16a-d. Non-round cross-sectional filler wire shapes in accordance with the present invention are characterized by outer perimeter surface sections having differing radii of curvature at different radials from their geometric center. Whereas the surface radius of curvature of a circular cross-section is constant at every radial intersection with the outer circumference, such relationship does not occur in non-round shapes.

FIG. 4 illustrates filler wire 16a oriented such that its major axis 32 (longer dimension) is perpendicular to beam axis 28, and minor axis 34 (smaller dimension) intersects (or is generally parallel to) the beam axis. Since the area of interaction between the beam 12 and filler wire 16a has a greater radius of curvature, i.e. it is “flatter” in the area of interaction with the laser beam (as compared to a round cross-section), enhanced radiation absorption is provided, enabling more repeatable and efficient heating and melting conditions. Moreover, if there is a slight lateral “skewing” of filler wire 16a in the direction of major axis 32 (as designated by the delta “Δ” in FIG. 4), the increased radius of curvature of the wire interacting with beam 12 continues to provide a better absorption conditions than would result using a round cross-sectional shaped wire having the same cross-sectional area.

In addition to the benefits of enhanced absorption of the radiant energy, filler wire 16a, due to its form, possesses advantageous mechanical characteristics which can reduce the previously described lateral skewing tendency. Due to its non-round cross-sectional shape, filler wire 16a-d has a greater bending stiffness in the plane of major axis 32 as compared with its bending stiffness in the plane of minor axis 34. This increased stiffness results in a reduced tendency of filler wire 16a to skew or deflect in the lateral direction (i.e. in the direction of major axis 32) during welding due to mechanical forces acting on the wire, softening of the wire by heat, and other factors. Also, the various guides, tubes and wire drives which transport the filler wire 16a-d from a storage drum (not shown) to torch 18 will cause the filler wire to be bent or deflected as it is transported. Due to the differing stiffnesses based on the plane of bending mentioned previously, filler wire 16a-d will tend to deflect in the plane of minor axis 34 as it is stored and transported. Therefore, there is a reduced tendency of wire 16a-d to have residual stresses which would tend to cause it to deflect in the direction of major axis 32 as it exits torch 18. This effect contributes to the ability to better maintain the lateral position of filler wire 16a-d as it interacts with laser beam 12, when the filler wire cross-section is oriented as shown by the figures. Another benefit of this mechanical characteristic is the ability to provide a larger separation between the end of torch 18 and the workpiece 14 which can be provided due to the greater stiffness of the wire and reduced skewing as it enters the weld bead area.

Now with reference to FIGS. 7A and 7B, a modified version of the invention is shown with non-round wire 16a-d interacting with a pair of laser beams 12a and 12b. As shown by these figures, a portion of the cross-sections of the beams 12a and 12b intersect filler wire 16a-d and the remaining beam cross-sections are incident on workpiece 14 (not shown in FIGS. 7A and 7B. In this instance, both beams 12a and 12b interact with a portion of filler wire 16a-d and the filler wire, having its greater length along its major axis 32 presents cross-sectional positions which interact with the separated beams 12a and 12b, which interaction is enhanced by the non-round cross-sectional shape of filler wire 16a-d. Another variation of the heating approach illustrated in FIGS. 7A and 7B is to use a single laser energy source 12 which is scanned or swept in the lateral direction along the outside of filler wire 16a-d, which is indicated by the arrow in FIG. 7B showing that laser beam 12b can be moved laterally in the direction of major axis 32. Examples of the pattern of such lateral sweeping can take the form of a sinusoidal, square wave, or saw tooth sweeping across the width of the filler wire as it is advanced into the weld bead area.

FIG. 8 is a pictorial view of another so-called hybrid welding process referred to as laser/MIG system (where filler wire 16a-d conducts electric current) or laser/plasma (where filler wire 16a-d is “cold” i.e. not conducting electric current). In these processes, laser beam 12 may not directly interact with filler wire 16a-d to melt the material of the filler wire. Here the material of workpiece 12 is heated by the radiant energy beam and this heating may be enhanced through energizing filler wire 16a-d with electric current. For such applications without direct interaction between the filler wire 16a-d and the beam, the benefits mentioned previously of enhanced direct absorptive interaction between the filler wire 16a-d and laser beam 12 are not present. However, there remain benefits in the use of non-round wire 16a-d in these applications. First, the enhanced mechanical characteristics of the non-round wire 16a-d as previously described are present which allow it to be more accurately positioned into the weld bead area with less skewing tendency. Furthermore, the flattened surface of the wire 16a-d confronting the workpiece 12 make it more receptive to radiant energy radiating from the weld molten metal pool area which enhances heating of the “backside” of filler wire 16a.

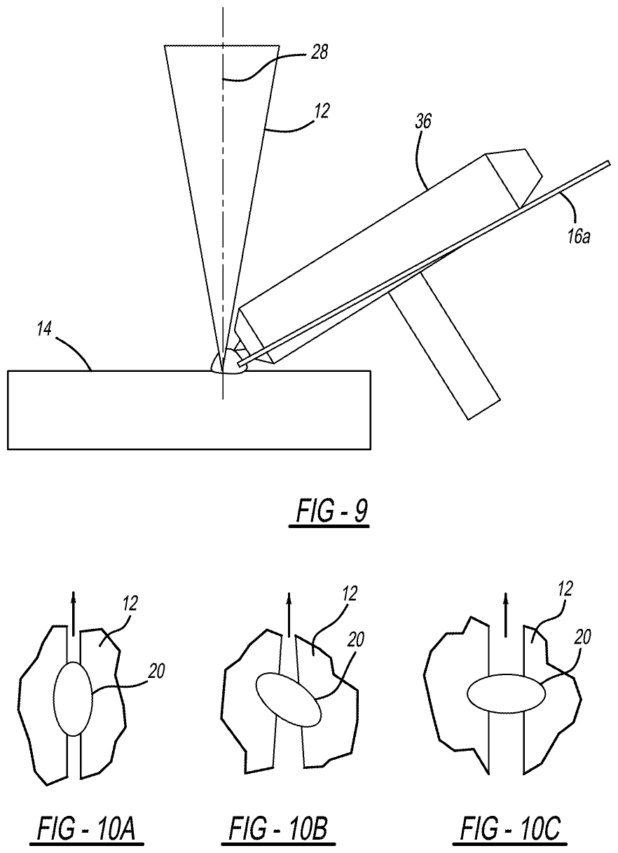

FIG. 9 represents a laser-plasma hybrid system. In this implementation, laser beam 12 acts with plasma torch 36 to provide thermal energy for the welding process. The interaction between the plasma volume created by plasma torch 36 and filler wire 16a-d is further enhanced by the non-round cross-sectional shape of the filler wire as there is better energy absorption.

FIGS. 10A-10C illustrated that the orientation of filler wire 16a-d can also influence the weld characteristics relative to the direction of the weld joint being created. In FIG. 10A, wire major axis 32 is aligned with the direction of advancement shown by the material edges shown. This is optimize for a narrow gap between the metal pieces be enjoined or where a deep penetration of the weld bead is desired. FIG. 10B shows a skewed orientation of the major axis 32 with respect to the weld joint direction. FIG. 10C shows major axis at right angles to the joint line in direction of advancement of the weld bead which will provide a wider bead with a shallower penetration.

In addition to the advantageous attributes of filler wire 16a-d in interactions with laser or plasma energy sources, it is noted that a non-round cross-sectional shape presents a larger surface area for the wire for a given cross-section volume, as compared with a round cross-section wire (which has the theoretically minimum circumference to area relationship). Such increased surface area can be exploited for more rapid heating and melting of wire 16a-d or other melting characteristics which may be especially advantageous for plasma or hybrid plasma welding systems. Moreover, in this description, wire 16a-d is referred to as a “filler wire”, which is more appropriate nomenclature for welding processes in which the wire is not conducting electric current (i.e. cold electrode). If the wire 16a-d conducts electric current (i.e. hot electrode) it would be more likely referred to as a “weld wire”. These descriptions are used interchangeably in this description.

In the above description, laser source 10 is specified as providing some or all of the thermal energy for creating the weld bead 26. However, the features of the present invention may be advantageous for other types of welding processes such as those using an electron beam or other radiant energy sources.

While the above description constitutes the preferred embodiment of the present invention, it will be appreciated that the invention is susceptible to modification, variation and change without departing from the proper scope and fair meaning of the accompanying claims.

1. A welding system for creating a weld bead on a workpiece comprising;
a radiant energy source creating a radiant energy beam defining a beam axis,
a wire providing a filler material or an electrode for the weld bead, the wire having a non-round cross-sectional shape presenting a surface portion having a relatively large radius of curvature, and a surface portion having a relatively small radius of curvature less than the relatively large radius of curvature, and
a weld torch for guiding the wire to a weld bead area of the workpiece, the weld torch orienting the wire such that the wire portion having a relatively large radius of curvature is positioned to at least partially intersect with the radiant energy beam along the beam axis.

2. A welding system in accordance with claim 1 further comprising the radiant energy source is provided in the form of a laser source.

3. A welding system in accordance with claim 1 further comprising the radiant energy source is further oriented such that the radiant energy beam further interacts with the workpiece along an area for the weld bead.

4. A welding system in accordance with claim 1 further comprising the non-round cross-sectional shape is one of elliptical or nearly elliptical, an oval, a square, a rectangle.

5. A welding system in accordance with claim 1 further comprising the non-round cross-sectional shape has a perimeter section which is defined by a straight line or a generally straight line.

6. A welding system in accordance with claim 1 further comprising the wire non-round cross-sectional shape is formed by the wire having a first round cross-sectional shape through a forming device having a pair of opposed rollers.

7. A welding system in accordance with claim 1 further comprising the longitudinal axis of the wire forms an oblique angle to the optical beam axis.

8. A welding system in accordance with claim 1 further comprising the welding system further comprising a plurality of the radiant energy sources presenting radiant energy beams defining separate optical beam axes, the plurality of radiant energy sources oriented such that the separate optical beams are at least partially incident on the wire.

9. A welding system in accordance with claim 1 further comprising the wire is energized with an electric current and conducts the electric current through the workpiece.

10. A welding system in accordance with claim 1 further comprising the weld torch providing a shielding gas flow for the weld bead.

11. A welding system in accordance with claim 1 further comprising the laser source and the torch are advanced along the workpiece to define a weld bead line and the wire cross-section defining a minor axis and a minor axis, the minor axis aligned to intersect or generally intersect the weld bead line or the beam axis.

12. A welding system in accordance with claim 1 further comprising the radiant energy beam axis is caused to sweep laterally with respect to the wire as the wire is advanced toward the weld bead.

13. A welding system in accordance with claim 1 further comprising the weld torch causing the wire to be advanced toward the weld bead as the torch is moved along a weld bead line along the workpiece.

14. A welding system in accordance with claim 16 further comprising the weld torch orienting the wire in an adjustable orientation with respect to the weld bead line.

15. A welding system in accordance with claim 1 further comprising a cross-section of the wire defining a major axis and a minor axis with the major axis having a larger dimension than the minor axis

16. A welding system for creating a weld bead on a workpiece comprising;
a radiant energy source creating a radiant energy beam having an optical beam axis,
a wire providing a filler material for the weld bead, the wire having a non-round cross-sectional shape presenting a portion having a relatively large radius of curvature, and a portion having a relatively small radius of curvature less than the relatively large radius of curvature, and
a weld torch for guiding the wire to a weld bead area of the workpiece, the weld torch orienting the wire such that the wire portion having a relatively large radius of curvature defining a tangent plane positioned to intersect the beam axis.

17. A welding system in accordance with claim 16 further comprising the radiant energy source is provided in the form of a laser source.

18. A welding system in accordance with claim 16 further comprising the radiant energy source is further oriented such that the radiant energy beam further interacts with the workpiece along an area for the weld bead.

19. A welding system in accordance with claim 16 further comprising the non-round cross-sectional shape is one of elliptical or nearly elliptical, an oval, a square, a rectangle.

20. A welding system in accordance with claim 16 further comprising the non-round cross-sectional shape has a perimeter section which is defined by a straight line or a generally straight line.

21. A welding system in accordance with claim 16 further comprising the wire non-round cross-sectional shape is formed by the wire having a first round cross-sectional shape through a forming device having a pair of opposed rollers.

22. A welding system in accordance with claim 16 further comprising the longitudinal axis of the wire forms an oblique angle to the optical beam axis.

23. A welding system in accordance with claim 16 further comprising the welding system further comprising a plurality of the radiant energy sources presenting radiant energy beams defining separate optical beam axes, the plurality of radiant energy sources oriented such that the separate optical beams are at least partially incident on the wire.

24. A welding system in accordance with claim 16 further comprising the wire is energized with an electric current and conducts the electric current through the workpiece.

25. A welding system in accordance with claim 16 further comprising the weld torch providing a shielding gas flow for the weld bead.

26. A welding system in accordance with claim 16 further comprising the laser source and the torch are advanced along the workpiece to define a weld bead line and the wire cross-section defining a minor axis and a minor axis, the minor axis aligned to intersect or generally intersect the weld bead line or the beam axis.

27. A welding system in accordance with claim 16 further comprising the radiant energy beam axis is caused to sweep laterally with respect to the wire as the wire is advanced toward the weld bead.

28. A welding system in accordance with claim 16 further comprising the weld torch causing the wire to be advanced toward the weld bead as the torch is moved along a weld bead line along the workpiece.

29. A welding system in accordance with claim 28 further comprising the weld torch orienting the wire in an adjustable orientation with respect to the weld bead line.

30. A welding system in accordance with claim 16 further comprising a cross-section of the wire defining a major axis and a minor axis with the major axis having a larger dimension than the minor axis

31. A method of creating a weld bead on a workpiece comprising;
providing a welding system including a radiant energy source creating a radiant energy beam having an optical beam axis,
providing a wire providing a filler material for the weld bead, the wire having a non-round cross-sectional shape presenting a portion having a relatively large radius of curvature, and a portion having a relatively small radius of curvature less than the relatively large radius of curvature, and
providing a weld torch for guiding the wire to a weld bead area of the workpiece,
orienting the weld torch such that the wire portion having a relatively large radius of curvature defining a tangent plane positioned to intersect the beam axis,
advancing the weld torch and the wire along a weld bead line such that the radiant energy beam heats the wire and the workpiece causing the wire to melt into the weld bead, and
feeding the wire through the weld torch as the weld torch is advanced along the weld bead line.

32. A method of creating a weld bead on a workpiece in accordance with claim 31 further comprising;
processing the wire by passing the wire having an initial round cross-sectional shape through one or more rollers whereby the rollers impress a flattened surface into the wire.
